(19) United States
(12) Patent Application Publication
(10) Pub. No.: US 2006/0171708 A1
(43) Pub. Date: Aug. 3, 2006

(54) Electronic device and case thereof

(75) Inventors: Kazunobu Iwata, Aichi (JP); Naoto Matsuyuki, Aichi (JP); Takeshi Ikari, Aichi (JP); Daisuke Ishii, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/334,331

(22) Filed: Jan. 18, 2006

(30) Foreign Application Priority Data
Jan. 19, 2005 (JP) 2005-011872

(51) Int. Cl. G03B 17/02

(52) U.S. Cl. 396/535

(57) ABSTRACT

Disclosed is an electronic device including: a functional unit built by assembling component parts and having a shape substantially resembling a flat, rectangular solid; and a case holding the functional unit therein and having a shape substantially resembling a flat, rectangular solid. In the device, the functional unit has a first major surface, a second major surface opposite the first major surface, and four side surfaces extending between the respective peripheries of the first and the second major surface; and the case has a first cover covering the first major surface of the functional unit, a second cover covering the second major surface of the functional unit, and a third cover covering three continuous ones of the four side surfaces of the functional unit.

### CROSS-REFERENCES TO RELATED APPLICATIONS

The present invention contains subject matter related to Japanese Patent Application No. 2005-011872 filed in the Japanese Patent Office on Jan. 19, 2005, the entire contents of which being incorporated herein by reference.

### BACKGROUND OF THE INVENTION

The present invention relates t an electronic device and a case thereof.

Each of most electronic devices has case holding therein a functional unit formed by assembling component parts of the electronic device. In most cases, the case is built by fastening together a plurality of wall members with screws. The screws fastening together the wall members of the case thus built appear on the surface of the case to spoil the aesthetic appearance of the electronic device. To avoid spoiling the aesthetic appearance of the electronic device, the heads of the screws are covered with concealing caps and concealing plugs attached to the case. Electronic devices having such a case are disclosed in JP-A 2000-223863 and JP-A 2001-24763.

### SUMMARY OF THE INVENTION

Those concealing caps and concealing plugs need to be attached individually to the case respectively for all the screws. Attaching the concealing caps and concealing plugs to the case requires troublesome work disadvantageous for the improvement of the efficiency of assembling work for assembling the electronic device.

The present invention has been made in view of the foregoing circumstances and it is therefore desirable to provide an electronic device having an aesthetically satisfactory appearance and facilitating assembling work, and a case for the electronic device.

An embodiment of the present invention is directed to an electronic device including a flat, substantially rectangular functional unit including necessary component parts, and a flat, substantially rectangular case attached to and covering the functional unit; wherein the functional unit has a first major surface, a second major surface opposite the first major surface and four side surfaces connecting the peripheries of the first and the second major surface, the case has a first covering member covering the first major surface of the functional unit, a second covering member covering the second major surface of the functional unit, and a third covering member covering the three connected side surfaces among the four side surfaces of the functional unit.

Another embodiment of the present invention is directed to an electronic device including a functional unit having a first major surface, a second major surface opposite the first major surface, and four side surfaces connecting the peripheries of the first and the second major surface, and a case covering the functional unit and having a first covering member covering the first major surface of the body, a second covering member covering the second major surface of the body, and a third covering member covering the three connected side surfaces among the four side surfaces of the functional unit.

According to the embodiments of the present invention, the third covering member covers the heads of screws fastening the first and the second covering member to the functional unit and lying in the side surfaces of the electronic device. Thus the heads of the screws do not need to be concealed individually by concealing caps and concealing plugs. Consequently, the electronic device has an aesthetically satisfactory appearance and facilitates assembling work.

### BRIEF DESCRIPTION OF THE DRAWINGS

The above and other objects, features and advantages of the present invention will become apparent from the flowing description taken in connection with the accompanying drawings, in which:

FIG. 1 is a perspective, front view of a digital still camera in a first embodiment according to the present invention;

FIG. 2 is a perspective, rear view of the digital still camera shown in FIG. 1;

FIG. 3 is an exploded perspective view of the digital still camera shown in FIG. 1;

FIG. 4 is a perspective view of assistance in explaining an assembling procedure for assembling the digital still camera shown in FIG. 1;

FIG. 5 is a schematic sectional view of an essential part of the digital still camera shown in FIG. 1;

FIG. 6 is a block diagram of a control system included in the digital still camera shown in FIG. 1;

FIG. 7 is an exploded perspective view of a digital still camera in a second embodiment according to the present invention;

FIG. 8 is a perspective view of a digital still camera in a second embodiment according to the present invention;

FIG. 9 is a perspective view of a game machine in a third embodiment according to the present invention;

FIG. 10 is an exploded perspective view of the game machine shown in FIG. 9; and

FIG. 11 is a sectional view of an essential part of a middle cover included in the game machine shown in FIG. 9.

### DETAILED DESCRIPTION

The present invention achieves the object by a functional unit formed by assembling first, second and third covers.

### FIRST EMBODIMENT

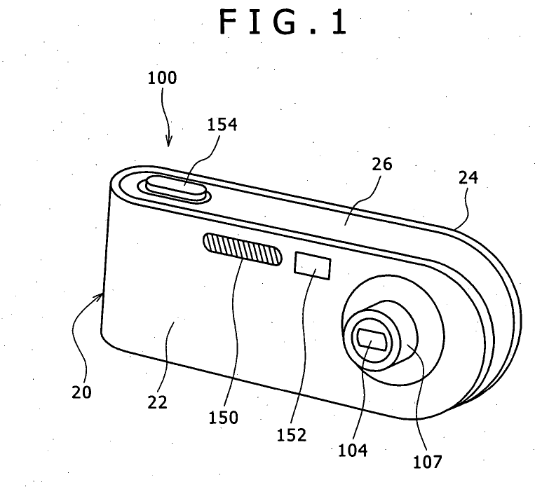

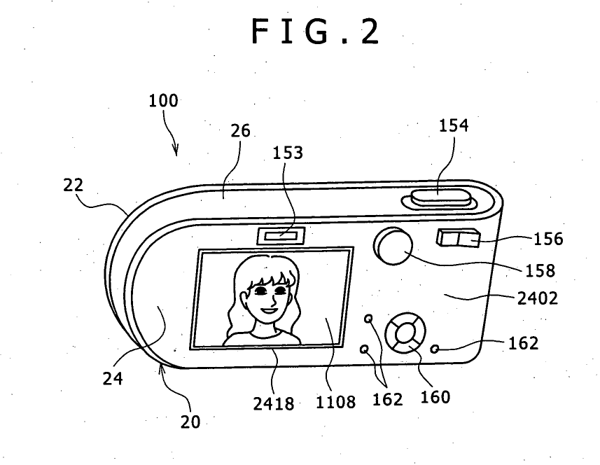

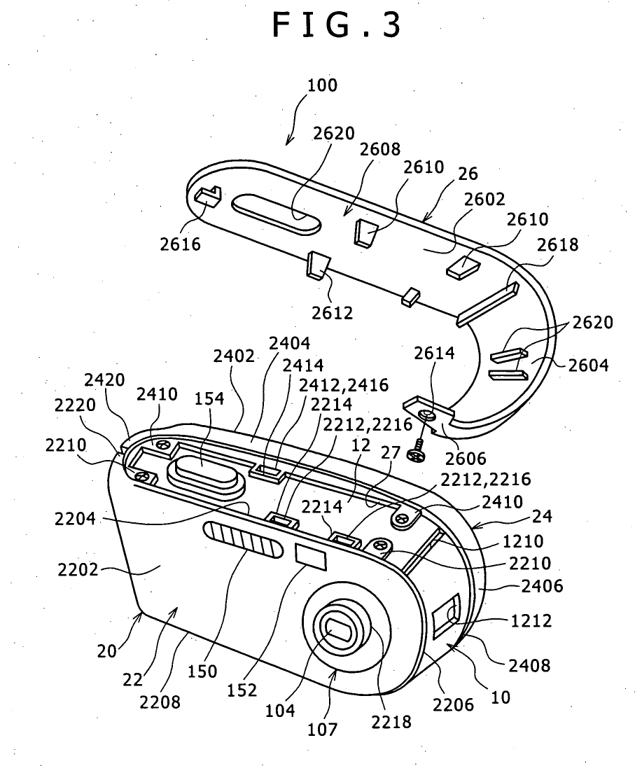

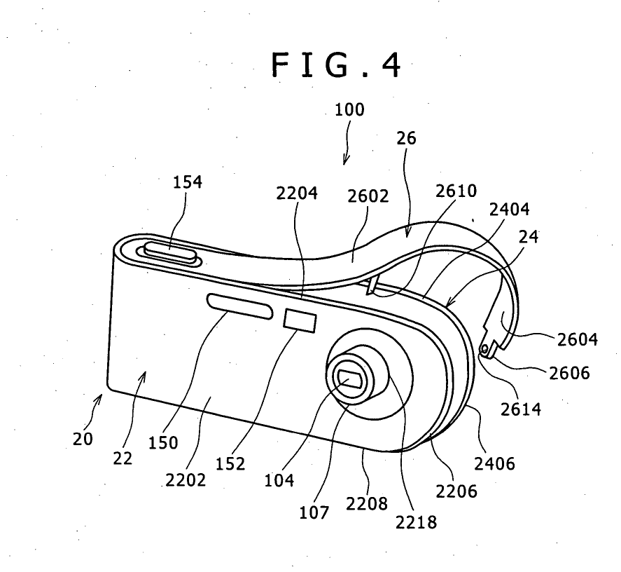

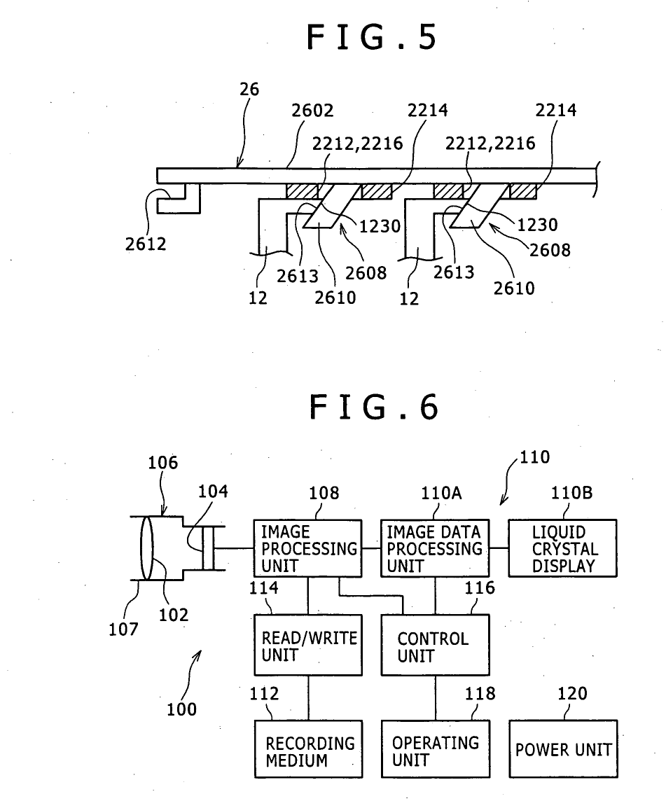

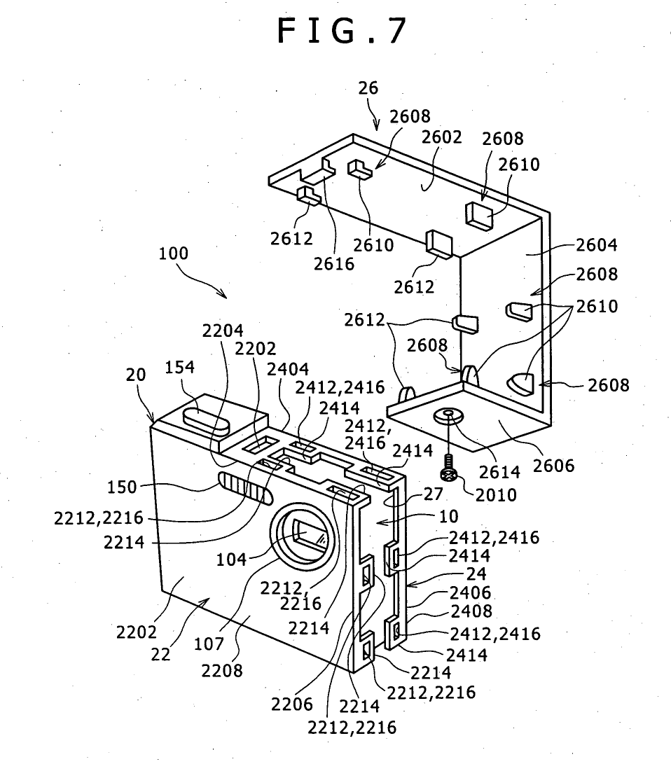

FIG. 1 is a perspective, front view of a digital still camera 100 in a first embodiment according to the present invention, FIG. 2 is a perspective, rear view of the digital still camera 100, FIG. 3 is an exploded perspective view of the digital still camera 100, FIG. 4 is a perspective view of assistance in explaining an assembling procedure for assembling the digital still camera 100, FIG. 5 is a schematic sectional view of an essential part of the digital still camera 100 and FIG. 6 is a block diagram of a control system included in the digital still camera 100.

Referring to FIG. 3, the digital still camera 100 has a functional unit 10 formed by assembling component parts, and a case 20 holding the functional unit 10 therein. As shown in FIG. 6, the component parts of the digital still camera 100 are a taking unit 106 including a taking optical system 102 and an image pickup device 104, an image processing unit 108 for processing image data on an image formed by the taking unit 106, a display unit 110 for displaying an image represented by the image data provided by the image processing unit 108, a read/write unit 114 for writing the image data provided by the image processing unit 108 to a recording medium 112, such as a memory card, and reading the image data from the recording medium 112, a control unit 116 for controlling those component parts, an operating unit 118 for giving operation signals to the control unit 116, and a power unit 120 for supplying power to those component parts.

The image pickup device 104 is a CCD or a CMOS sensor capable of converting an object image formed by the taking optical system 102 into corresponding electric signals. The display unit 110 includes an image data processing unit 11OA for processing image data provided by the image processing unit 108, and a liquid crystal display 110B for displaying an image represented by processed image data provided by the image data processing unit 110A. The control unit 116 controls the taking unit 106, the image processing unit 108, the display unit 110 and the read/write unit 114 on the basis of operation signals given thereto by the operating unit 118. The functional unit 10 is built by containing those component parts in a case. In another case, those component parts are mounted on a frame to build the functional unit 10.

In this specification, the terms right and left are used to specify parts, sides and such of the still camera 100 and the case 20 on the right side and the left side, respectively, as viewed from the front side of the digital still camera 100.

Referring to FIGS. 1 and 2, the taking unit 106 has a lens barrel 107 holding the taking optical system 102 and the image pickup device 104. A stroboscope window 150 and a finder window 152 are formed in an upper part of the front wall of the digital still camera 100. A shutter switch 154 is placed on the upper wall of the digital still camera 100. A finger window 153 is formed in the back wall of the digital still camera 100. The finder window 153 is optically connected to the finer window 152. Placed on the back wall of the digital still camera 100 are the liquid crystal display 110B, a zooming switch 156 for zooming the taking optical system 102, a mode selector switch 158 for selecting one of operating modes including a taking mode and a reproducing mode, a cross switch 160 for setting operations and a plurality of setting switches 162. These switches are included in the operating unit 118.

The functional unit 10 is built by assembling the foregoing component parts and has shape substantially resembling a flat, rectangular solid. The functional unit 10 has a first major surface, a second major surface opposite the first major surface and four side surfaces connecting the edges of the first and the second major surface. Thus the first and the second major surface and the four side surfaces form the shape substantially resembling the flat, rectangular solid. In this embodiment, the first major surface of the functional unit 10 is a front surface and the second major surface is a back surface, and the four side surfaces are top, bottom, right and left surfaces.

The functional unit 10 includes a frame 12 holding the component parts. The case 20 has a front cover 22, namely, a first cover, a back cover 24, namely, a second cover, and a middle cover 26, namely, a third cover, connecting the front cover 22 and the back cover 24.

Referring to FIG. 3, the front cover 22 has a front part 2202 covering the front surface of the functional unit 10, an upper edge part 2204 covering a front peripheral part of the functional unit 10, a side edge part 2206 covering a front peripheral part of the side surface of the functional unit 10, and a lower edge part 2208 covering a front peripheral part of the bottom surface of the functional unit 10. The side edge part 2206 has a substantially semicircular shape in a vertical plane. Mounting lags 2210 protrude backward from opposite end parts of the upper edge part 2204. The mounting lags 2210 are fastened to the upper wall of the frame 12 with screws. The upper edge part 2204 of the front cover 22 is provided with a first holding structure 2212 overlying the upper wall of the frame 12. The first holding structure 2212 includes two laterally spaced lags 2214 respectively provided with laterally elongate rectangular openings 2216. A window 2218 is formed in the front part 2202. The lens barrel 107 of the taking optical system 104 protrudes forward through the window 2218. The front part 2202 covers the front surface of the functional unit 10 with the lens barrel 107 projected forward from the front part 2202.

Referring to FIG. 3, the back cover 24 has a back part 2402 covering the back surface of the functional unit 10, an upper edge part 2404 covering a back peripheral part of the top surface of the functional unit 10, a side edge part 2406 covering a back peripheral part of the side surface of the functional unit 10, and a bottom edge part 2408 covering a back peripheral part of the bottom surface of the functional unit 10. The side edge part 2406 has a substantially semicircular shape in a vertical plane. The side edge part 2206 of the front cover 22 and the side edge part 2406 of the back cover 24 have the same outline. An open space 27 is defined by the front cover 22 and the back cover 24. The open space 27 opens between the upper edge parts 2204 and 2404, between the side edge parts 2206 and 2406 and between the bottom edge parts 2208 and 2408 of the front cover 22 and the back cover 24 to expose the top surface, the side surfaces and the bottom surface of the functional unit 10. Mounting lags 2410 protrude forward from opposite end parts of the upper edge part 2404. The mounting lags 2410 are fastened to the upper wall of the frame 12 with screws. The upper edge part 2404 is provided with a second holding structure 2412 overlying the upper wall of the frame 12. The holding structure 2412 includes a lag 2414 provided with a laterally elongate rectangular openings 2416. As shown in FIG. 2, the back part 2402 is provided with a window 2418. The screen of the liquid crystal display 110B is fitted in the window 2418. The back part 2402 covers the back surface of the functional unit 10 with the screen of the liquid crystal display 11OB exposed through the window 2418.

Referring to FIGS. 3 and 4, the middle cover 26 covers the opening the openings of the space 27. The middle cover 26 has an upper part 2602 covering the top surface of the functional unit 10, a side part 2604 covering the side surface of the functional unit 10, and a lower part 2606 partially covering the bottom surface of the functional unit 10. The middle cover 26 is made of a synthetic resin and is capable of being elastically deformed. The upper part 2602 is provided with a window 2620 in a left part thereof. A shutter switch 154 is fitted in the window 2620. The side part 2604 is formed in a substantially cylindrical shape so as to extend along the respective outlines of the side edge part 2206 of the front cover 22 and the side edge part 2406 of the back cover 24. The upper part 2602 and the side part 2604 are formed in a uniform width. The lower part 2606 is formed in a width smaller than that of the upper part 2602 and the side part 2604. The middle cover 26 covers the openings of the space 27 closely. When the front cover 22, the back cover 24 and the middle cover 26 are assembled, adjacent edge parts of the front cover 22, the back cover 24 and the middle cover 26 are flush with each other and any steps are not formed at boundaries between the front cover 22 and the middle cover 26 and between the back cover 24 and the middle cover 26. The upper part 2602 covers the upper surface of the frame 12, the mounting lags 2210 and 2410, first holding structure 2212 and the second holding structure 2412. A hook 2616 is formed in a left end part of the upper part 2602 so as to protrude from the inner surface of the upper part 2602 toward the frame 12. When the middle cover 26 is joined to the front cover 22 and the back cover 24, the hook 2616 is engaged with respective joining parts 2220 and 2420 of the upper edge parts 2204 and 2404 of the front cover 22 and the back cover 24. A third holding structure 2608 is formed on the inner surface of the upper part 2602 facing the frame 12. When the middle cover 26 is joined to the front cover 22 and the back cover 24, the third holding structure 2608 engages with the first holding structure 2212 and the second holding structure 2412 to hold the middle cover 26 firmly on the front cover 22 and the back cover 24 so as to cover the mounting lags 2210 and 2410, the first holding structure 2212, the second holding structure 2412 and the upper surface of the frame 12.

The third holding structure 2608 includes locking projections 2610 and 2612. The locking projections 2610 engages in the openings 2216 of the first holding structure 2212. The locking projection 2612 engages in the opening 2416 of the second holding structure 2412. Referring to FIG. 5, the locking projections 2610 and 2612 have inclined edges 2613 facing the hook 2616. The edges 2613 extend obliquely toward the functional unit 10 from the inner surface of the upper part 2602 of the middle cover 26 so as to approach the hook 2616 with distance toward the functional unit 10. When the first holding structure 2212, the second holding structure 2412 and the third holding structure 2608 are engaged with the locking projections 2610 engaged in the opening 2216 of the first holding structure 2212 and the locking projection 2612 engaged in the opening 2416 of the second holding structure 2412, the inclined edges 2613 of the locking projections 2610 and 2612 are in engagement with inclined surfaces 1230 formed in the frame 12. The inclined surfaces 1230 are inclined in the same direction as the inclined edges 2613. When the middle cover 26 is turned on the hook 2616 toward the functional unit 10 after engaging the hook 2616 with the respective joining parts 2220 and 2420 of the upper edge parts 2204 and 2404 of the front cover 22 and the back cover 24 to insert the locking projections 2610 and 2612 in the openings 2216 of the first holding structure 2212 and the opening 2416 of the second holding structure 2412, respectively, the inclined edges 2613 of the locking projections 2610 and 2612 slide smoothly along the inclined surfaces 1230.

A through hole 2614 is formed in the lower part 2606. The middle cover 26 is fastened to the frame 12 of the functional unit 10 by engaging the third holding structure 2608 with the first holding structure 2212 and the second holding structure 2412 and by fastening the lower part 2606 to the frame 12 with a screw passed through the through hole 2614 and screwed in a threaded hole, not shown, formed in the bottom surface of the frame 12 of the functional unit 10. As shown in FIG. 3, a straight rib 2618 is formed in a part of the inner surface at the boundary of the upper part 2602 and the side part 2604, and two straight ribs 2620 are formed on the inner surface of the side part 2604 in parallel to the rib 2618. The rib 2618 is engaged in a groove 1210 formed in the frame 12 to position the middle cover 26 with respect to lateral directions, and the two ribs 2620 are engaged in a recess 1212 to position the side part 2604 with respect to vertical directions.

A case assembling procedure for assembling the case 20 will be explained. Referring to FIG. 3, the mounting lags 2210 of the upper edge part 2204 of the front cover 22 are fastened to the upper surface of the frame 12 with screws. The mounting lags 2410 of the upper edge part 2404 of the back cover 24 are fastened to the upper surface of the frame 12 with screws. Subsequently, the upper part 2602 of the middle cover 26 is disposed opposite to the upper opening of the space 27, the upper part 2602 is warped elastically in an upward concave shape, and the hook 2616 is engaged with the respective joining parts 2220 and 2420 of the upper edge parts 2204 and 2404 of the front cover 22 and the back cover 24 as shown in FIG. 4. Then, the middle cover 26 is turned toward the functional unit 10 on the hook 2616 to insert the locking projections 2610 and 2612 in the openings 2216 of the first holding structure 2212 and the opening 2416 of the second holding structure 2412, respectively, to engage the third holding structure with the first holding structure 2212 and the second holding structure 2412. Consequently, the elastic middle cover 26 elastically restores its original shape and fits closely in the openings of the space 27. After the space 27 has been thus closely covered with the upper part 2604, the side part 2606 and the lower part 2608 of the middle cover 26, the screw is passed through the through hole 2614 formed in the lower part 2608 and is screwed in the threaded hole, not shown, formed in the bottom surface of the frame 12 of the functional unit 10. Thus the middle cover 26 is fastened to the frame 12 of the functional unit 10.

The case 20 holding the functional unit 10 therein includes the front cover 22 covering the front surface of the functional unit 10, a back cover 24 covering the back surface of the functional unit 10, and a middle cover 26 covering the upper surface, the side surface and the bottom surface of the frame 12 of the functional unit 10. The heads of the screws fastening the front cover 22 and the back cover 24 to the functional unit 10 can be covered concealed with the middle cover 26. Since the heads of those screws are thus concealed by the cover 20 including the front cover 22, the back cover 24 and the middle cover 26, any concealing caps and any covers for concealing the heads of the screws do not need to be attached to the case 20. Thus case 20 can be easily assembled and the aesthetic appearance of the digital still camera 100 is not spoiled. The middle cover 26 having the upper part 2602, the side part 2604 and the lower part 2606 is elastic and flexible. Therefore, the middle cover 26 can be easily and securely connected to the front cover 22 and the back cover 24 by using the holding structures 2212, 2212 and 2412. Consequently, the case 20 and the functional unit 10 can be assembled by easy assembling work. Since the middle cover 26 is held between the front cover 22 and the back cover 24, the case 20 is robust.

### SECOND EMBODIMENT

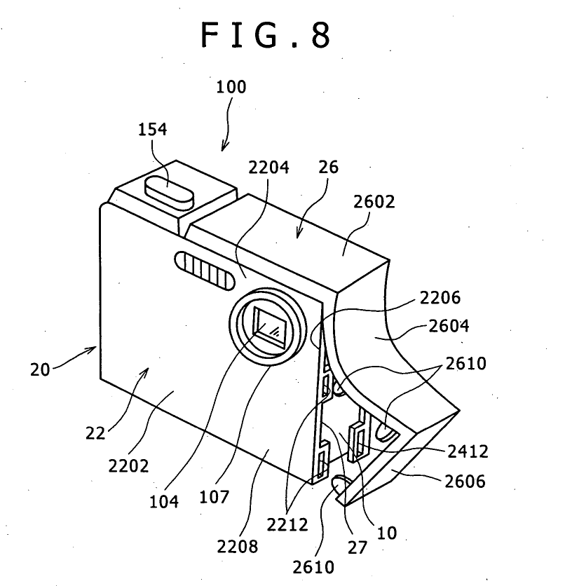

A digital still camera 100 in a second embodiment according to the present invention will be described with reference to FIGS. 7 and 8, in which parts like or corresponding to those of the digital still camera 100 in the first embodiment are denoted by the same reference characters and the description thereof will be omitted.

FIG. 7 is an exploded perspective view of the digital still camera 100 in the second embodiment and FIG. 8 is a perspective view of the digital still camera 100 shown in FIG. 7. A case 20 holding a functional unit 10 has a front cover 22 covering the front surface of the functional unit 10, a back cover 24 covering the back surface of the functional unit 10, and a middle cover 26 covering the top, the side and the bottom surface of the functional unit 10. The front cover 22 and the back cover 24 are formed in a single piece so as to define an open space 27. The case 20 is formed by assembling the covers 22, 24 and 26. The functional unit 10 is inserted into the open space 27 through the open left end or the open bottom end of the open space 27. The front cover 22 and the back cover 24 are fastened to the functional unit 10 with screws, not shown.

The front cover 22 is provided with a first holding structure 2212 lying on the top, the side and the bottom surface of the functional unit 10. The first holding structure 2212 includes two laterally spaced projections 2214 respectively provided with laterally elongate rectangular openings 2216 and extending backward along the top surface of the functional unit 10 from an upper edge part 2204 of the front cover 22, two vertically spaced projections 2214 respectively provided with vertically elongate rectangular openings 2216 and extending backward along the side surface of the functional unit 10 from a side edge part 2206 of the front cover 22, and a projection, not shown, provided with a laterally elongate rectangular opening and extending backward along the bottom surface of the functional unit 10 from a bottom edge part 2208 of the front cover 22.

The back cover 24 is provided with a second holding structure 2412 lying on the top, the side and the bottom surface of the functional unit 10. The second holding structure 2412 includes two laterally spaced projections 2414 respectively provided with laterally elongate rectangular openings 2416 and extending forward along the top surface of the functional unit 10 from an upper edge part 2404 of the back cover 24, two vertically spaced projections 2414 respectively provided with vertically elongate rectangular openings 2416 and extending forward along the side surface of the functional unit 10 from a side edge part 2406 of the back cover 24, and a projection, not shown, provided with a laterally elongate rectangular opening and extending forward along the bottom surface of the functional unit 10 from a bottom edge part 2408 of the back cover 24.

As shown in FIGS. 7 and 8, the middle cover 26 closes the open space 27. The middle cover 26 has an upper part 2602, a side part 2604 and a lower part 2606 for covering the top, the side and the bottom surface of the functional unit 10, respectively. The side part 2604 of the middle cover 26 is flat. The upper part 2602, the side part 2604 and the lower part 2606 are formed in the same uniform width. The middle cover 26 covers the open space 27 closely. The upper part 2602, the side part 2604 and the lower part 2606 cover the first holding structure 2212, the second holding structure 2412 and the top, the side and the bottom surface of the functional unit 10. A hook 2616 is formed on the inner surface of the upper part 2602 facing the functional unit 10 at a position opposite the side part 2604. The hook 2616 engages in an opening 2002 formed at the joint of the front cover 22 and the back cover 24. A third holding structure 2608 is formed on the inner surfaces, facing the top, the side and the bottom surface of the functional unit 10, of the upper part 2602, the side part 2604 and the lower part 2606. The third holding structure 2608 is engaged with the first holding structure 2212 and the second holding structure 2412 to cover the top, the side and the bottom surface of the functional unit 10 with the middle cover 26.

The third holding structure 2608 includes locking projections 2610 and 2612 projecting from the inner surface of the upper part 2602 facing the top surface of the functional unit 10. The locking projections 2610 are engaged in the openings 2216 of the first holding structure 2212. The locking projections 2612 are engaged in the openings 2416 of the second holding structure 2412.

A through hole 2614 is formed in the lower part 2606. The middle cover 26 is fastened to the functional unit 10 by engaging the third holding structure 2608 with the first holding structure 2212 and the second holding structure 2412 and by fastening the lower part 2606 to the functional unit 10 with a screw passed through the through hole 2614 and screwed in a threaded hole, not shown, formed in the bottom surface of the functional unit 10.

A case assembling procedure for assembling the case 20 will be explained. Referring to FIG. 7, the functional unit 10 is inserted in the space 27 defined by the front cover 22 and the back cover 24, and the upper part 2602 of the middle cover 26 is disposed opposite to the space 27. Subsequently, the hook 2616 is engaged in the opening 2202, the side part 2604 is warped elastically in an upward concave shape as shown in FIG. 8. Then, the middle cover 26 is turned toward the functional unit 10 on the hook 2616 to insert the locking projections 2610 and 2612 in the openings 2216 of the first holding structure 2212 and the openings 2416 of the second holding structure 2412, respectively, to engage the third holding structure with the first holding structure 2212 and the second holding structure 2412. Consequently, the elastic middle cover 26 elastically restores its original shape and closes the space 27 closely. After the space 27 has been thus closed closely with the upper part 2604, the side part 2606 and the lower part 2608 of the middle cover 26, the screw is passed through the through hole 2614 formed in the lower part 2608 and is screwed in the threaded hole, not shown, formed in the bottom surface of the functional unit 10. Thus the middle cover 26 is fastened to the functional unit 10.

The back edge of the front cover 22 and the front edge of the back cover 24 on the upper and the side surface of the digital still camera 100 can be covered with the middle cover 26 to finish the digital still camera 100 in an aesthetically satisfactory appearance. The case 20 can be easily assembled. The elastic middle cover 26 having the upper part 2602, the side part 2604 and the lower part 2606 can be elastically warped. Therefore, the case 20 can be easily and securely assembled by engaging the holding structures 2212, 2412 and 2608. The case 20 facilitates assembling work. Since the middle cover 26 is held between the front cover 22 and the back cover 24 by engaging the third holding structure 2608 with the first holding structure 2212 and the second holding structure 2412, the case 20 is robust.

### THIRD EMBODIMENT

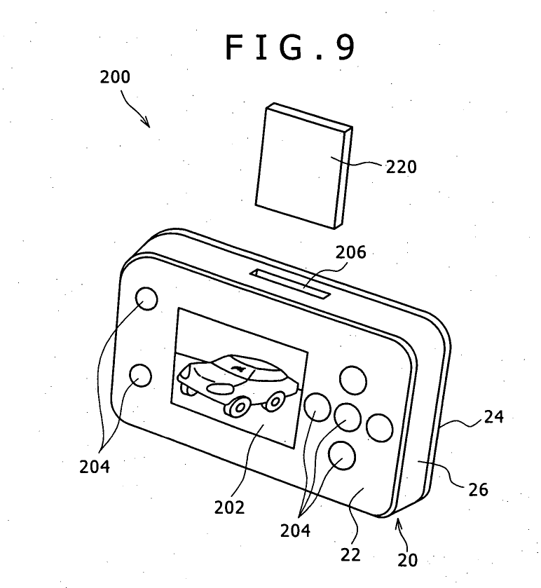

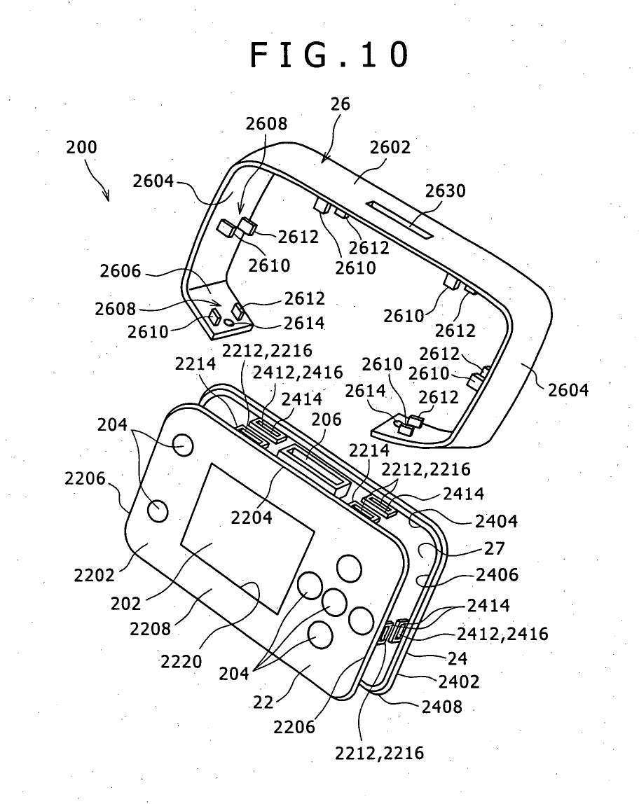

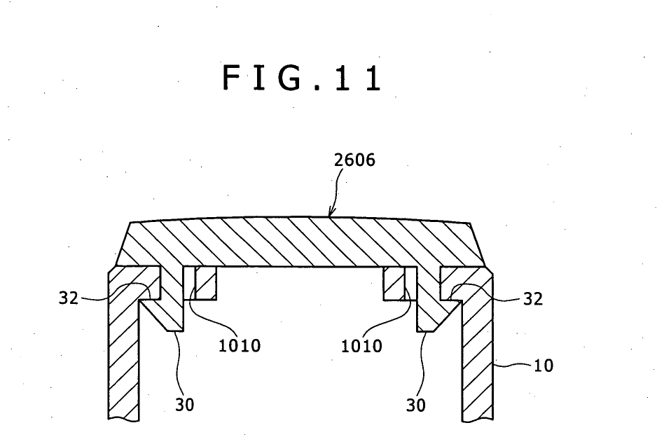

A portable game machine 200 in a third embodiment according to the present invention will be described with reference to FIGS. 9 and 10. FIG. 9 is a perspective view of the game machine 200 in the third embodiment, FIG. 10 is an exploded perspective view of the game machine 200 and FIG. 11 is a sectional view of an essential part of a middle cover 26 included in the game machine 200.

As shown in FIG. 9, the game machine 200 has a functional unit 10 formed by assembling component parts, and a case 20 holding the functional unit 10 therein. The component parts include a control unit that reads game software from a cartridge 220 storing the game software and executes control operations on the basis of the game software, an image processing unit for processing image data processed by the control unit, a display unit including a liquid crystal display 202 for displaying pictures represented by image data processed by the image processing unit, an operating unit including a plurality of control buttons 204 for entering instructions into the control unit, and a power unit for supplying power to the component parts. The liquid crystal display 202 is placed in a central part of the front wall of the game machine 2002, and the control buttons 204 are arranged around the liquid crystal display 202 on the front wall of the game machine 200. The cartridge 220 can be detachably loaded into the game machine 200 through a loading slot 206 formed in a middle part of the upper wall of the game machine 200.

The case 20 has a front cover 22, a back cover 24 and a middle cover 26 respectively for covering the front surface, the back surface, and the top, right and left side and bottom surfaces of the functional unit 10.

Referring to FIG. 10, the front cover 22 has a front part 2202 covering the front surface of the functional unit 10, an upper edge part 2204 covering a front edge part of the upper surface of the functional unit 10, side edge parts 2206 covering front edge parts of the side surfaces of the functional unit 10, and a lower edge part 2208 covering a front edge part of the bottom surface of the functional unit 10.

The front cover 22 is provided with a first holding structure 2212. The first holding structure includes two laterally spaced projections 2214 respectively provided with laterally elongate rectangular openings 2216 and extending backward from the upper edge part 2204, one projection 2214 provided with a vertically elongate rectangular opening 2216 and extending backward from the right side edge part 2206, one projection 2214 provided with a vertically elongate rectangular opening 2216 and extending backward from the left side edge part 2206, and two laterally spaced projections, not shown, respectively provided with laterally elongate rectangular openings and extending backward from the lower edge part 2208. A window 2220 is formed in the front part 2202. The screen of the liquid crystal display 202 is fitted in the window 2220.

Referring to FIG. 10, the back cover 24 has a back part 2402 covering the back surface of the functional unit 10, an upper edge part 2404 covering a back edge part of the upper surface of the functional unit 10, side edge parts 2406 covering back edge parts of the side surfaces of the functional unit 10, and a lower edge part 2408 covering a back edge part of the bottom surface of the functional unit 10. An open space 27 is defined by the front cover 22 and the back cover 24. The open space 27 opens between the upper edge parts 2204 and 2404, between the side edge parts 2206 and 2406 and between the bottom edge parts 2208 and 2408 of the front cover 22 and the back cover 24 to expose the top surface, the side surfaces and the bottom surface of the functional unit 10.

The back cover 24 is provided with a second holding structure. The second holding structure includes two laterally spaced projections 2414 respectively provided with laterally elongate rectangular openings 2416 and extending forward from the upper edge part 2404, one projection 2414 provided with a vertically elongate rectangular opening 2416 and extending forward from the right side edge part 2406, one projection 2414 provided with a vertically elongate rectangular opening 2416 and extending forward from the left side edge part 2406, and two laterally spaced projections, not shown, respectively provided with laterally elongate rectangular openings and extending forward from the lower edge part 2408.

Referring to FIGS. 9 and 10, the middle cover 26 covers the space 27. The middle cover 26 has an upper part 2602 covering the top surface of the functional unit 10, side parts 2604 covering the right and left sides of the functional unit 10, and lower parts 2606 partially covering the bottom surface of the functional unit 10. The upper part 2602 of the middle cover 26 is provided in its middle part with a laterally elongate opening 2630. A frame defining the slot 206 is fitted in the opening 2630. The side parts 2604 are flat and straight. The upper part 2602, the side parts 2604 and the lower parts 2606 are formed in the same uniform width. The middle cover 26 covers the space 27 closely. The upper part 2602, the side parts 2604 and the lower parts 2606 of the middle cover 26 cover the first holding structure 2214, the second holding structure 2412, the top, side and bottom surfaces of the functional unit 10.

The middle cover 26 is provided with a third holding structure 2608. The third holding structure is engaged with the first holding structure 2212 and the second holding structure 2412 to join the middle cover 26 to the front cover 22 and the back cover 24 so as to cover the top surface, the side surfaces and the bottom surface of the functional unit 10.

The third holding structure 2608 includes locking projections 2610 formed on the inner surfaces, facing the top surface, the side surfaces and the bottom surfaces of the functional unit 10, of the upper part 2602, the side parts 2604 and the lower parts 2606 so as to be engaged in the openings 2216 of the projections 2212 of the first holding structure 2212, and locking projections 2612 formed on the inner surfaces, facing the top surface, the side surfaces and the bottom surfaces of the functional unit 10, of the upper part 2602, the side parts 2604 and the lower parts 2606 so as to be engaged in the openings 2416 of the projections 2412 of the second holding structure 2412.

The lower parts 2606 are provided with through holes 2614, respectively. The middle cover 26 is put on the functional unit 10 with the third holding structures 2608 engaged with the first holding structure 2212 and the second holding structure 2412, and screws passed through the through holes 2614 of the lower parts 2606 are screwed in threaded holes formed in the bottom surface of the functional unit 10 to fasten the middle cover 26 to the functional unit 10.

A case assembling procedure for assembling the case 20 will be explained. Referring to FIG. 10, the functional unit 10 is inserted in the space 27 defined by the front cover 22 and the back cover 24, and the upper part 2602 of the middle cover 26 is disposed opposite to the space 27. Subsequently, the side parts 2604 are bent elastically outward together with the lower parts 2606. Then, the upper part 2602 of the middle cover 26 is moved toward the functional unit 10 to engage the locking projections 2610 and 2612 formed on the inner surface of the upper part 2602 in the openings 2216 of the first holding structure 2212 and the openings 2416 of the second holding structure 2412, respectively, to engage the third holding structure 2608 with the first holding structure 2212 and the second holding structure 2412. Then, the elastically bent side parts 2606 are released. Consequently, the middle cover 26 elastically restores its original shape and the locking projections 2610 and 2612 of the side parts 2604 and the lower parts 2606 are engaged in the openings 2216 of the first holding structure 2212 and the openings 2416 of the second holding structure 2412, respectively, to engage the third holding structure 2608 with the first holding structure 2212 and the second holding structure 2412. Thus the space 27 is closely closed. After the space 27 has been thus closed closely with the upper part 2604, the side part 2606 and the lower part 2608 of the middle cover 26, the screws are passed through the through holes 2614 formed in the lower parts 2608 and are screwed in the threaded hole, not shown, formed in the bottom surface of the functional unit 10. Thus the middle cover 26 is fastened to the functional unit 10.

The case 20 of the game machine 200 in the third embodiment having the front cover 22, the back cover 24 and the middle cover 26 covers and conceals the heads of screws and the holding structures for holding the front cover 22, the back cover 24 and the middle cover 26 together. Therefore, any concealing caps and any covers for concealing the heads of the screws do not need to be attached to the case 20. Thus case 20 can be easily assembled and the aesthetic appearance of the game machine 200 is not spoiled. The middle cover 26 having the upper part 2602, the side part 2604 and the lower part 2606 is elastic and flexible. Therefore, the middle cover 26 can be easily and securely connected to the front cover 22 and the back cover 24 by using the holding structures 2212, 2212 and 2412. Consequently, the case 20 and the functional unit 10 can be assembled by easy assembling work. Since the middle cover 26 is held between the front cover 22 and the back cover 24, the case 20 is robust.

In each of the first to the third embodiment, the lower part 2606 of the middle cover 26 is fastened to the functional unit 10 with the screw. The lower part 2606 of the middle cover 26 may be connected to the functional unit 10 by a connecting mechanism shown in FIG. 11. As shown in FIG. 11, the connecting mechanism has locking projections 30 each provided with a hooked end 32 that engages in an opening 1010 formed in the functional unit 10. Each of the locking projections 2610 and 2612 may have the hooked end 32. When the locking projections 2610 are provided with hooked ends 32, respectively, the middle cover 26 cannot be removed unless the middle cover 26 is broken. Therefore, the disassembly and modification of the game machine 200 can be readily known and the locking projections 2610 respectively having the hooked ends 32 are effective in obstructing the disassembly and modification of the game machine 200.

Although the invention has been described as applied to the digital still camera and the game machine, it is obvious that the present invention is applicable to a variety of electronic devices. Although the invention has been described as applied to the electronic devices to be used in a vertical position, it goes without saying that the present invention is applicable to electronic devices to be used in horizontal, vertical, tilted positions.

It should be understood by those skilled in the art that various modifications, combinations, sub-combinations and alterations may occur depending on design requirements and other factors insofar as they are within the scope of the appended claims or the equivalents thereof.

1. An electronic device comprising:
a functional unit built by assembling component parts and having a shape substantially resembling a flat, rectangular solid; and
a case holding the functional unit therein and having a shape substantially resembling a flat, rectangular solid;
wherein the functional unit has a first major surface, a second major surface opposite the first major surface, and four side surfaces extending between the respective peripheries of the first and the second major surface; and
the case has a first cover covering the first major surface of the functional unit, a second cover covering the second major surface of the functional unit, and a third cover covering three continuous ones of the four side surfaces of the functional unit.

2. The electronic device according to claim 1, wherein the first major surface of the functional unit is a front surface, the second major surface is a back surface, one of the four side surfaces is a top surface, the two other side surfaces are right and left side surfaces continuous with the top surface, and the other one side surface is a bottom surface continuous with the right and the left side surface, the first cover is a front cover covering the front surface of the functional unit, the second cover is a back cover covering the back surface of the functional unit, and the third cover is a middle cover covering the top surface, the side surfaces continuous with the top surface, and the bottom surface continuous with the side surfaces.

3. The electronic device according to claim 2, wherein mounting lags formed in an upper part of the front cover are attached to the top surface of the functional unit, mounting lags formed in an upper part of the back cover are attached to the top surface of the functional unit, and the middle cover covers the mounting lags and the top surface of the functional unit.

4. The electronic device according to claim 2, wherein the functional unit includes a frame, the component parts of the functional unit are mounted on the frame, the mounting lags formed in the upper part of the front cover are attached to the top surface of the frame, the mounting lags formed in the upper part of the back cover are attached to the top surface of the frame, and the middle cover covers the mounting lags and the top surface of the frame.

5. The electronic device according to claim 2, wherein a first holding structure is formed in an upper part of the front cover so as to overlie the top surface of the functional unit, a second holding structure is formed in an upper part of the back cover so as to overlie the top surface of the functional unit, a third holding structure is formed on an inner surface, facing the top surface of the functional unit, of the middle cover, and the middle cover covers the first and the second holding structure and the top surface of the functional unit when the middle cover is joined to the front and the second cover with the third holding structure engaged with the first and the second holding structure.

6. The electronic device according to claim 2, wherein a first holding structure is formed in an upper part of the front cover so as to overlie the top surface of the functional unit, a second holding structure is formed in an upper part of the back cover so as to overlie the top surface of the functional unit, a third holding structure is formed on an inner surface, facing the top surface of the functional unit, of the middle cover, the middle cover covers the first and the second holding structure and the top surface of the functional unit when the middle cover is joined to the front and the second cover with the third holding structure engaged with the first and the second holding structure, and a part of the middle cover covering the bottom surface of the functional unit is fastened to the functional unit.

7. The electronic device according to claim 2, wherein a first holding structure is formed in an upper part of the front cover so as to overlie the top surface of the functional unit, a second holding structure is formed in an upper part of the back cover so as to overlie the top surface of the functional unit, a third holding structure is formed on an inner surface, facing the top surface of the functional unit, of the middle cover, the middle cover covers the first and the second holding structure and the top surface of the functional unit when the middle cover is joined to the front and the second cover with the third holding structure engaged with the first and the second holding structure, and a lower part of the middle cover covering the bottom surface of the functional unit is fastened to the functional unit by passing a screw through a through hole formed in the lower part of the middle cover and screwing the screw in a threaded hole formed in the bottom surface of the functional unit.

8. The electronic device according to claim 2, wherein the front cover has a front part covering the front surface of the functional unit, an upper edge part covering a front edge part of the top surface of the functional unit, side edge parts covering front edge parts of the side surfaces of the functional unit, and a lower edge part covering a front edge part of the bottom surface of the functional unit;
the back cover has a back part covering the back surface of the functional unit, an upper edge part covering a back edge part of the top surface of the functional unit, side edge parts covering back edge parts of the side surfaces of the functional unit, and a lower edge part covering a back edge part of the bottom surface of the functional unit;
the top surface, the side surfaces and the bottom surface of the functional unit are exposed in an opening extending between the upper edge parts, openings each extending between the side edge parts and an opening extending between the lower edge parts of the front and the back cover; and
the openings defined by the front and the back cover are covered with the middle cover.

9. The electronic device according to claim 2, wherein the middle cover has an upper part covering the top surface of the functional unit, a side part covering the side surface of the functional unit and a lower part covering the bottom surface of the functional unit, the middle cover has a width in a longitudinal direction, and the upper and the lower part of the middle cover has the same uniform width.

10. The electronic device according to claim 2, wherein any step is not formed in a boundary between adjacent parts of the front and the middle cover and the surfaces of the adjacent parts of the front and the middle cover are flush with each other, any step is not formed in a boundary between adjacent parts of the back and the middle cover and the surfaces of the adjacent parts of the back and the middle cover are flush with each other when the front, the back and the middle cover are assembled to cover the functional unit.

11. The electronic device according to claim 2, wherein the middle cover is held between the front and the back cover when the front, the back and the middle cover are assembled to cover the functional unit.

12. The electronic device according to claim 2, wherein the middle cover has an upper part for covering the top surface of the functional unit, a side part for covering the side surface of the functional unit and a lower part for covering the bottom surface of the functional unit, and the middle cover is elastically deformable.

13. The electronic device according to claim 2 is a camera, wherein one of the component parts is a lens barrel holding a taking mechanism including a taking optical system, the front cover is provided with a window for receiving the taking optical system, the front cover covers the front surface of a camera body so that the taking optical system projects forward through the window, the middle cover is provided with a window for receiving an operating member of a shutter switch protrude outside, and the middle cover covers the top surface of the camera body so that the operating member of the shutter switch protrude upward through the window.

14. The electronic device according to claim 2 is a portable game machine, wherein one of the component parts is a liquid crystal display panel, the front cover is provided with a window, and the front cover covers the front surface of the functional unit of the portable game machine so that the liquid crystal display panel is fitted in the window.

15. A case for an electronic device having a functional unit formed by assembling component parts and having a shape resembling a flat, rectangular solid having a first major surface, a second major surface opposite the first major surface, and four side surfaces extending between the respective peripheries of the first and the second major surface, said case comprising:
a first cover covering the first major surface of the functional unit;
a second cover covering the second major surface of the functional unit; and
a third cover covering three continuous ones of the four side surfaces of the functional unit.
